(19) United States
(12) Patent Application Publication
(10) Pub. No.: US 2024/0209269 A1
(43) Pub. Date: Jun. 27, 2024

(54) METHOD OF FUEL OIL HYDROCRACKING

(71) Applicants: Roman ILIEV, Moscow (RU); Valeriia MASALEVICH, Zarechye (RU); Eduard TALANOV, Moscow (RU)

(72) Inventors: Roman ILIEV, Moscow (RU); Valeriia MASALEVICH, Zarechye (RU); Eduard TALANOV, Moscow (RU); Aleksandr VYGONIAILO, Moscow (RU)

(21) Appl. No.: 18/288,864

(22) PCT Filed: Apr. 25, 2022
(86) PCT No.: PCT/RU2022/050137

§ 371 Date: Oct. 30, 2023

(30) Foreign Application Priority Data
Apr. 30, 2021 (RU) 2021112753

(51) Int. Cl. C10G 47/34

(52) U.S. Cl. CPC C10G 47/34; C10G 2300/1081; C10G 2300/70

(57) ABSTRACT

An invention relates to fuel oil hydrocracking in the presence of methane and is designed to produce distillate products with a density of 835-850 kg/m³. The technical result is to simplify the process of fuel oil hydrocracking by performing it at reduced temperature and pressure, as well as to increase the yield of distillate products. A method of fuel oil hydrocracking is proposed, wherein fuel oil is heated to 90-110° C. and mixed with methane fed at a pressure of 0.8-1.2 MPa, resulting mixture of fuel oil with methane is heated to 280-380° C. and fed to the hydrocracking reactor for hydrocracking in the presence of promoted catalyst, and the resulting vapors are transferred to a rectification unit with subsequent cooling of the separated streams to get fuel oil distillates with a density of 805-850 kg/m³. The optimal mass ratio in the fuel oil and methane mixture is 80:20, and the catalyst is a mixture of oxides of elements of the scandium and titanium subgroups of the periodic table belonging to different and any even period of the periodic table, taken in equal molar fractions and applied to aluminum oxide. In this case, the catalyst can be promoted with a composite material consisting of fifth-period metals and periodic table elements with atomic numbers 75 to 83.

### FIELD OF THE INVENTION

An invention relates to fuel oil hydrocracking in the presence of methane and is designed to produce distillate products with a density of 835-850 kg/m³.

### PRIOR ART

The method of hydrocracking of heavy crude hydrocarbons described in the patent RU 2169170, published Jun. 20, 2001, is known from the prior art. This method of hydrocracking involves feeding hydrogen or hydrogen gas in an amount of 20-30 wt. % of the amount of reagents in the reaction chamber and bringing gas pressure in the chamber to 10-30 MPa and temperature to 1300-1500 K. The processed raw materials in the amount of 70-80 wt. % of the amount of reagents is fed into a chamber with heated hydrogen and mixed with hydrogen, the resulting mixture is cracked at a total contact time of raw materials with hydrogen, equal to 2-12 ms, then the reaction products are quenched at a simultaneous decrease in temperature and pressure for 5-10 ms and transfer to separate the target products. Approbation of method of fuel oil hydrocracking allowed to obtain gaseous products (CH4, C2H4, C2H6, C3H8, C4) in the amount of 42,266 wt. % of reaction products; gasoline (C5, C6, C7, C8, C9, C10, C11, C12) in the amount of 34,096 wt. %; diesel fuel (C13-C20) in the amount of 17,284 wt. % at conversion rate of 98-99%.

The disadvantage of the prototype, which is recognized as a method of hydrocracking according to the patent RU 2169170, is performing the method at high temperature and extreme pressure, as well as low product yield due to the large volume of the obtained gas.

### DISCLOSURE OF THE INVENTION

The technical result of the claimed invention is to simplify the process of fuel oil hydrocracking by performing it at reduced temperature and pressure, as well as to increase the yield of distillate products.

The specified result is achieved by the proposed method of fuel oil hydrocracking wherein fuel oil is heated to 90-110° C. and mixed with methane fed at a pressure of 0.8-1.2 MPa, resulting mixture of fuel oil with methane is heated to 280-380° C. and fed to the hydrocracking reactor for hydrocracking in the presence of promoted catalyst, and the resulting vapors are transferred to a rectification unit with subsequent cooling of the separated streams to get fuel oil distillates with a density of 805-850 kg/m³.

In one embodiment of the invention, the mass ratio of the fuel oil to methane mixture is 80:20.

In one embodiment of the invention, the catalyst is a mixture of oxides of elements of the scandium and titanium subgroups of the periodic table belonging to different and any even period of the periodic table, taken in equal molar fractions and applied to aluminum oxide. In this case, the catalyst can be promoted with a composite material consisting of fifth-period metals and periodic table elements with atomic numbers 75 to 83.

In the following, the claimed invention will be disclosed in detail.

### DETAILED DESCRIPTION

A method of fuel oil hydrocracking with a density of 910-1000 kg/m³ is proposed.

The raw material (fuel oil) is fed to the feed tank. The feed tank contains a heating element for heating and a temperature controller. In the tank the raw material is heated to a temperature of 90-110° C. The heated fuel oil is pumped through a strainer to mix with natural gas (methane) in a static mixer, made, for example, as part of the pipeline connecting the feed tank and the heating furnace. The flow of fuel oil is controlled by a flow meter. To bring the amount of fuel oil to normal conditions (to control the flow of raw materials), a temperature correction factor can be entered: +8% of the volume for every +100 degrees increase in temperature from 20 degrees.

Methane is fed into the static mixer at a pressure of 0.85 to 1.2 MPa, for example, from a cylinder. The cylinder may contain a heated reducer that prevents the reducer from freezing. Methane flow can also be controlled by a flow meter. A correction factor of 10-20% of the raw material weight can be applied to bring it to normal conditions.

It has been established by practical means that for the effective yield of the end product the optimum mass ratio of fuel oil and natural gas in the mixer is 80:20.

The resulting mixture of fuel oil and methane at a pressure of 0.85-1.2 MPa and a temperature of 90-110° C. is fed from the mixer into the furnace for further heating. The furnace can use, for example, induction or another type of heating. The mixture is heated to 280-380° C. and transferred to the hydrocracking reactor for methane cracking.

The hydrocracking reactor is a tank for filling with a regular packing and contains internal mechanical elements in the form of concentric shells and flow direction devices. Similar reactors (reaction chambers) designed for industrial chemical or physical-chemical processes are known from the prior art.

In the reactor, the interaction of two streams is realized: the gaseous stream-methane, and the liquid stream-fuel oil. It provides hydrocracking of the feed mixture. The interaction in the reactor takes place in the presence of a promoted catalyst realized in the form of a regular packing. Regular packings are packets of vertical plates arranged parallel to the axis of the reactor column and made of perforated corrugated sheets of a complex configuration.

In the reactor, under the influence of the promoter and catalyst, hydrogen is redistributed between hydrogen-rich molecules and hydrogen-poor molecules to form saturated hydrocarbons with boiling points not exceeding the maintained temperature in the reactor.

The catalyst used in the reactor is designed to:
C5-C18 isomerization without separation;
olefin metathesis;
reduction of sulfur content;
hydrogen disproportionation;
cracking.

A mixture of oxides of third-group and fourth-group elements belonging to different and any even periods, taken in equal molar fractions, is used as a catalyst. One example of a catalyst is, but is not limited to, a mixture of scandium oxide with titanium oxide. The oxides are deposited on a carrier, namely aluminum gamma oxide with a surface area of at least 200 m²/g. The total proportion of oxides must not exceed 10% of the carrier weight.

The catalyst is promoted with a promoter, which is a composite material, consisting of fifth-period metals and periodic table elements with atomic numbers 75 to 83. The amount of elements 75 to 83 is 40 to 75 wt. %, and the amount of fifth-period metals is 25 to 60 wt. %. One example of a composite material is the niobium-zinc material. The composite material must be encapsulated in a sealed steel capsule with an internal cross section of at least 11 millimeters and a shape made up of straight and curved surfaces. The proportion of curved surfaces must be at least 60%. Variants of the form—cylinder, lens, sphere. The composite filling ratio of the container is 45 to 70% of the volume. The promoter capsule creates a region of space in which the conditions for chemical reactions change. The presence of the promoter reduces the cost of the catalytic process, including the process using industrial catalysts. For example, one laboratory recorded a 3.5-fold decrease in activation energy.

After the reactor, the product vapors is transferred to the rectification unit, where the product stream is separated into three fractions: heavy, medium and light. The light fraction includes light distillates of which 90 vol. % or more (including losses) are distilled at 210 degrees Celsius (ASTM D 86 method). The medium fraction includes medium distillates of which less than 90 vol. % (including losses) are distilled at 210 degrees Celsius and 65 vol. % or more (including losses) are distilled at 250 degrees Celsius by ASTM D 86 method. The heavy fraction includes heavy distillates of which less than 65 vol. % (including losses) are distilled at 250 degrees Celsius by ASTM D 86 method, or whose distillation percentage at 250 degrees Celsius cannot be determined by this method.

After the rectification unit, the product streams pass through condensing heat exchangers and cooling heat exchangers. Each stream is transferred to its own collector, where the resulting product is measured (weighed).

The end product is distillates with a density of 805-850 kg/m³.

The proposed method made it possible to reduce the sulfur content in the end product by an average of 6 times, that is, to obtain distillates with sulfur content of 0.068-0.082%. Distillates have similar distillation curves. At the same time, 95% of distillates evaporate in the range of 250-330° C.

This process of methane doping of fuel oil with its conversion into a mixture of distillate products under the influence of the promoted catalyst is low-cost and runs smoothly under very mild conditions.

1. A method for hydrocracking of a fuel oil, comprising
heating said fuel oil to 90-110° C.,
feeding methane at a pressure of 0.85-1.2 MPa to said fuel oil to obtain a mixture,
heating said mixture to 280-380° C. and feeding to a hydrocracking reactor for hydrocracking in the presence of a promoted catalyst,
transferring vapors obtained from the hydrocracking reactor to a rectification unit to obtain separated streams;
cooling said separated streams to get fuel oil distillates.

2. The method according to claim 1, wherein the promoted catalyst is a mixture of oxides of elements of the scandium and titanium subgroups of the periodic table belonging to different and any even period of the periodic table, taken in equal molar fractions, and wherein said mixture of oxides is deposited on aluminum oxide.

3. The method according to claim 2, wherein the promoted catalyst is promoted with a composite material consisting of fifth-period metals and periodic table elements with atomic numbers 75 to 83.

4. The method according to claim 1, wherein a mass ratio of the fuel oil to methane within said mixture is 80:20.
